(19) United States
(12) Patent Application Publication
(10) Pub. No.: US 2008/0169357 A1
(43) Pub. Date: Jul. 17, 2008

(54) Fuel Injector That Opens In Two Stages

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/908,424

(22) PCT Filed: Mar. 7, 2006
(86) PCT No.: PCT/EP2006/060514

§ 371 Date: Sep. 12, 2007

(30) Foreign Application Priority Data
Apr. 12, 2005 (DE) 102005016796.9

(51) Int. Cl. F02M 45/08; F02M 47/02

(52) U.S. Cl. 239/91; 239/533.3; 239/533.9

(57) ABSTRACT

A fuel injector having a stroke reversal with a two-stage pressure booster. If the piezoelectric actuator expands, then via a control piston, a pressure p₂ is briefly elevated in a second control chamber and a booster piston is displaced counter to a closing direction, as a result of which the pressure p₂ of the hydraulic fluid in the second control chamber rises again. The booster piston carries an injection valve member along with it produces a first opening motion of the injection valve member. By the motion of the control piston in the closing direction, a pressure p₁ in a first control chamber is briefly reduced. The first control chamber is in communication, via a pressure equalization conduit, with a differential pressure chamber of the injection valve member and the pressure p₃ in the differential pressure chamber also drops, producing a further, hydraulic force further raising the injection valve member.

The invention relates to a fuel injector that opens in two stages for injecting fuel into a combustion chamber of an internal combustion engine. In particular, the invention relates to a fuel injector with direct needle control and hydraulic stroke reversal.

### PRIOR ART

For supplying combustion chambers of self-igniting internal combustion engines with fuel, both pressure-controlled and stroke-controlled injection systems can be employed. Besides unit fuel injectors and pump-line-nozzle units, reservoir-type injection systems can be used as fuel injection systems. Reservoir-type injection systems (common rails) advantageously make it possible to adapt the injection pressure to the load and rpm of the engine.

From the prior art, common rail injectors with piezoelectric actuators are known, in which a nozzle needle is controlled via the pressure in one or more control chambers. The pressure in this control chamber or these control chambers is controlled via the piezoelectric actuator and optionally one or more control valves. In such constructions, the nozzle needle is thus indirectly controlled by the piezoelectric actuator.

Besides these indirectly controlled common rail injectors, systems have meanwhile become known from the prior art in which a nozzle needle is controlled directly by a piezoelectric actuator. Such injectors have a high opening and closing speed as well as usually a comparatively simple injector construction. Such injectors, however, require long piezoelectric actuators in order to attain the necessary nozzle needle stroke.

From European Patent Disclosure EP 1 174 615 A2, a fuel injector is known which has a valve element that cooperates with a valve seat in order to control a fuel injection from the injector. Moreover, the fuel injector has an actuator and a booster, and the booster transmits an actuator motion to the valve element.

The arrangement described in EP 1 174 615 A2, like many other arrangements with direct needle control known from the prior art, has various disadvantages. For instance, the injector described is in particular an injector with so-called “inverse needle control”. In order for the fuel injector to be closed, the valve member must be pressed into the valve seat in order to close the injection openings. However, the fuel injector is in this state only when current is being supplied to the actuator and the actuator thus has its maximum possible longitudinal expansion. In the state of repose, conversely, or in other words when there is no current to the actuator, the injection openings are opened. This has the disadvantage in particular that the actuator must largely continue to be supplied with current, which puts a constant load on the actuator and shortens the service life of the actuators and thus of the fuel injectors considerably.

### ADVANTAGES OF THE INVENTION

A fuel injector for injecting fuel into a combustion chamber of an internal combustion engine is proposed which has the advantages of direct needle control and at the same time avoids the above-described disadvantages of inverse needle control. A fundamental concept of the present invention is to employ a hydraulic stroke reversal, in particular a two-stage hydraulic stroke reversal.

The effect of this hydraulic stroke reversal is that a longitudinal expansion of the actuator leads to opening of the injection valve and hence to tripping of the injection event, while an ensuing contraction of the actuator conversely causes closure of the fuel injector. In this way, the actuator, for instance in the state of repose (fuel injector closed; no injection), can be kept in the currentless state, in other words acted upon with no or only slight voltage, and accordingly can be subjected to appropriate current or voltage only for tripping the injection event.

It is also a fundamental concept of the present invention that a two-stage stroke reversal is employed. In this two-stage stroke reversal, a stroke booster is employed, which causes an inverse boosting of the expansion of the actuator. As the second stage of the stroke boosting, a differential pressure chamber of the stroke booster can be utilized.

The fuel injector has an injection valve member, which is movable linearly in a closing direction and which opens or closes at least one injection opening in an injector body via at least one sealing seat. The fuel injector furthermore has at least one actuator, acting linearly in the closing direction, which can preferably be a piezoelectric actuator. Still other types of actuators are conceivable, such as magnet actuators or similar actuators. The fuel injector furthermore has at least one control piston, movable linearly in the closing direction by the actuator, as well as at least one booster piston, inversely coupled to the at least one control piston via a second control chamber and displaceable linearly in the closing direction. The at least one booster piston is displaceable counter to the closing direction by a motion of the at least one control piston in the closing direction.

The inverse coupling between the at least one control piston and the at least one booster piston can be effected for instance by providing that the at least one second control chamber is defined substantially by the injector body, at least one second sealing sleeve, the at least one booster piston, and the at least one control piston. The at least one booster piston and the at least one control piston should each have at least one hydraulically effective area inside the at least one second control chamber, and these hydraulically effective areas have the same sign with regard to the closing direction. This assures that a motion of the at least one control piston in one direction (for instance in the closing direction), via a hydraulic fluid (such as fuel) located in the at least one second control chamber, causes a motion of the at least one booster piston in the opposite direction (thus for instance counter to the closing direction). The stroke ratio of the motions of the control piston and the booster piston is defined in each case by the inverse ratio of the respective hydraulically effective areas inside the second control chamber.

The fuel injector furthermore has at least one first control chamber, and at least one volume of the at least one first control chamber can be increased by means of a displacement of the at least one control piston in the closing direction. This can be done in particular by providing that the at least one first control chamber is defined substantially by the injector body, at least one first scaling sleeve, and the control piston. The at least one first control chamber is in fluidic communication with a differential pressure chamber, and a pressure reduction in the at least one differential pressure chamber acts upon the injection valve member with a hydraulic force counter to the closing direction. This can be effected by providing that the at least one differential pressure chamber is defined substantially by the at least one booster piston and at least one hydraulically effective area of the injection valve member.

In particular, the at least one first control chamber and the at least one differential pressure chamber can communicate fluidically via at least one pressure equalization conduit let into the at least one control piston and/or into the at least one booster piston. Advantageously, this at least one pressure equalization conduit has at least one throttle element, for instance a throttle element in the form of a constriction in the at least one pressure equalization conduit.

The fuel injector can be designed in particular such that the at least one control piston is embodied at least partly as a sleeve and at least one surrounds the at least one booster piston, and the at least one control piston and the at least one booster piston are displaceable linearly counter to one another. Moreover, the at least one booster piston can be embodied at least in part as a sleeve and partly surround the injection valve member, and the at least one booster piston and the injection valve member are displaceable closely counter to one another.

If the at least one linear actuator is triggered, for instance subjected to current, then a longitudinal expansion of the at least one actuator ensues, and the at least one control piston is displaced in the closing direction. As a result, a first pressure p₁ of a hydraulic fluid in the at least one first control chamber is briefly lowered, and a second pressure p₂ of a hydraulic fluid in the at least one second control chamber is elevated. As a result of the pressure increase of the pressure p₂, the at least one booster piston is displaced counter to the closing direction, and the second pressure p₂ of the hydraulic fluid drops again. Moreover, hydraulic fluid flows (possibly in delayed fashion because of the throttle element) out of the at least one differential pressure chamber through the at least one pressure equalization conduit into the at least one first control chamber, and between the at least one differential pressure chamber and the at least one first control chamber, a pressure equalization essentially occurs. As a result, a third pressure p₃ of the hydraulic fluid drops in the at least one differential pressure chamber, as a result of which the injection valve member is lifted counter to the closing direction and opens the at least one injection opening.

Alternatively or in addition, the invention may also be designed such that the at least one booster piston has a slaving device, for instance a mechanical stop, which is suitable for slaving the injection valve member upon a motion of the at least one booster piston counter to the closing direction. In this embodiment, when the at least one booster piston moves counter to the closing direction, initially a slaving of the injection valve member is effected counter to the closing direction, and hence a rapid opening of the injection valve member. The pressure drop in the at least one differential pressure chamber caused by the reduction of the pressure p₁ in the at least one first control chamber then causes an additional lifting of the injection valve member counter to the closing direction, and hence an additional stroke of the injection valve member. This embodiment has the overall effect that even with comparatively short actuators, such as piezoelectric actuators, an adequate stroke of the injection valve member can be achieved, and thus a sufficient injection of fuel into the combustion chamber of the engine is assured.

### DRAWING

The invention is described in further detail below in conjunction with the drawing.

Shown is:

FIG. 1, one exemplary embodiment of a fuel injector with direct needle control and two-stage stroke reversal.

### EXEMPLARY EMBODIMENT

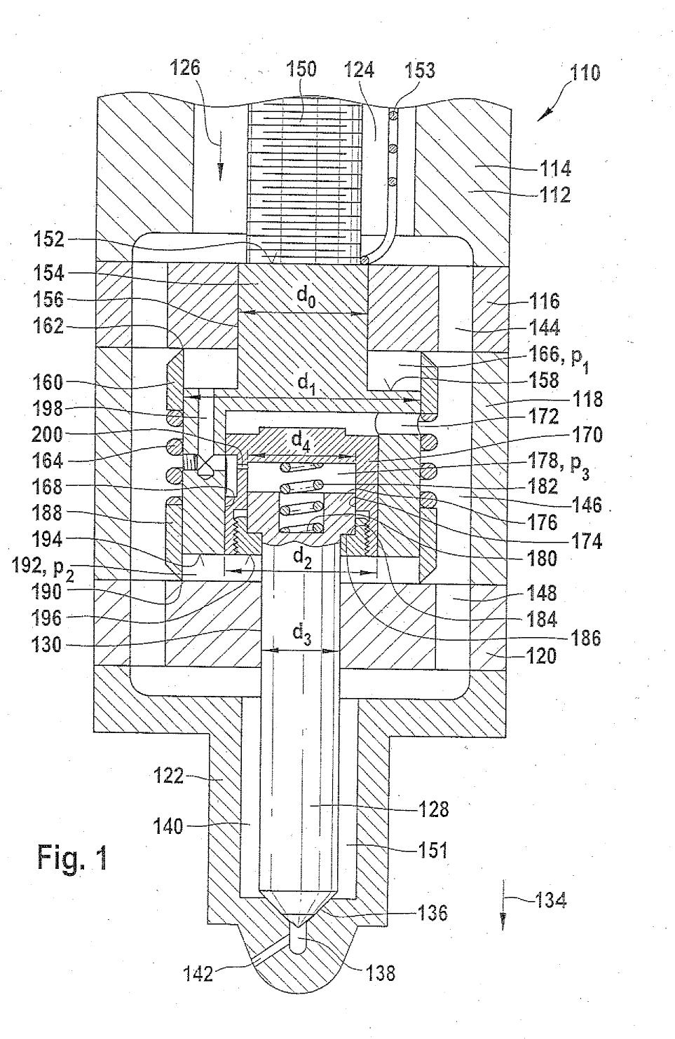

The sole drawing (FIG. 1) shows a preferred exemplary embodiment of a fuel injector 110 for injecting fuel into a combustion chamber of an internal combustion engine. The fuel injector 110 has an injector body 112, which is of modular construction and includes an actuator chamber body 114, a first intermediate element 116, a pressure chamber body 118, a second intermediate element 120, and a nozzle chamber body 122. The fuel injector 110 communicates via a high-pressure line (not shown), which discharges into an actuator chamber 124 of the fuel injector 110 (the fuel inlet is symbolically represented by the arrow 126), with a pressure reservoir (common rail), from which the fuel injector 110 is supplied with fuel that is under pressure.

The fuel injector 110 has an injection valve member 128, which is supported by means of a guide portion 130 in the second intermediate element 120 in such a way that the injection valve member 128 is displaceable parallel to a closing direction 134. The injection valve member 128 is designed conically in its lower end in terms of the closing direction 134. If the injection valve member 128 is subjected to a force in the closing direction 134, the injection valve member 128 is pressed into a sealing seat 136, as a result of which a blind borelike region 138 of a needle chamber 140 is sealed off tightly against fuel, and as a result of that, injection openings 142 let into a wall of the blind borelike region 138 are closed in fuel-tight fashion.

The fuel flowing out of the fuel inlet 126 into the actuator chamber 124 of the fuel injector 110 can flow through first fuel conduits 144 (for instance in the form of bores in the first intermediate element 116) from the actuator chamber 124 into a pressure chamber 146 and from there, via further fuel conduits 148 in the second intermediate element 120, the fuel can reach the needle chamber 140. Inside the needle chamber 140, the fuel can flow along an annular gap 151 between the injection valve member 128 and the nozzle chamber body 122 to reach the sealing seat 136.

The fuel injector 110 furthermore has a piezoelectric actuator 150, which is let into the actuator chamber 124 and can be supplied with current or voltage via electrical contacts (not shown), in such a way that a longitudinal expansion of the piezoelectric actuator 150 in the closing direction 134 can ensue. The piezoelectric actuator 150 is sheathed in fuel-tight fashion, to prevent damage to the piezoelectric actuator 150 from the fuel under pressure in the actuator chamber 124

The piezoelectric actuator 150 is prestressed via a prestressing element 153 and is firmly connected at a control face 152 to a control piston 154. The control piston 154 is supported linearly displaceably in the closing direction 134 by means of a guide region 156 in the first intermediate element 116. The control piston 154, in its upper region guided inside the guide region 156, is embodied as a solid cylinder with a diameter d₀, and in its lower region, which is supported inside the pressure chamber 146, it is widened to a diameter d₁. At the transition between the region of diameter d₀ and the region of diameter d₁, a shoulder 158 is embodied, in the form of a face 158 that is perpendicular to the closing direction 134. This shoulder 158 acts as a hydraulic face 158 of the control piston 154. In the region of this shoulder 158, the control piston 154 is surrounded by a first sealing sleeve 160, which has the shape of a hollow cylinder with an inside diameter d₁. On its upper edge, the first sealing sleeve 160 is provided with a bite edge 162. By means of a spring element 164, the first sealing sleeve 160 is pressed against the first intermediate element 116, and as a result, between the first sealing sleeve 160, the first intermediate element 116 and the control piston 154, a first control chamber 166 is created, which has the form of a concentric circular cylinder around the control piston 154 and which is sealed off in fuel-tight fashion from the remainder of the pressure chamber 146 by the sealing sleeve 160.

The control piston 154 is embodied in its lower region as a hollow cylinder and has a cylindrical hollow chamber 168 of diameter d₂. Placed inside this hollow chamber 168 is a booster piston 170, likewise designed essentially cylindrically in its external dimensions, with an outer diameter d₂. This booster piston 170 is displaceable inside the hollow chamber 168 linearly parallel to the closing direction 134 counter to the control piston 154. A relief conduit 172 in the control piston 154 assures that the hollow chamber 168 that remains between the booster piston 170 and the control piston 154 always has the same fuel pressure as the remaining pressure chamber 146.

The booster piston 170, in its interior, has a substantially cylindrical hollow chamber 174. The injection valve member 128, which in the region of the guide portion 130 is cylindrical in shape with a diameter d₃, has a cylindrical thickened portion 176 of diameter d₄ on its upper end, and this portion is let into the hollow chamber 174 of the booster piston 170 in such away that the booster piston 170 surrounds this widened upper portion 176; between the upper portion 176 of the injection valve member 128 and the booster piston 170, a differential pressure chamber 178 is formed. The injection valve member 128, with its upper portion 176, is movable in the hollow chamber 174 in such a way that the differential pressure chamber 178 is sealed off essentially in fuel-tight fashion from the surroundings (that is, in particular from a second control chamber 192; see below). The entire face, oriented toward the differential pressure chamber 178 and perpendicular to the closing direction 134, of the injection valve member 128, which overall has a graduated circular area of diameter d₄, thus forms a hydraulically effective area of the injection valve member 128. The injection valve member 128 furthermore has an indentation 180 in its upper portion 176, inside which indentation a nozzle spring 182 is supported by way of which the injection valve member 128 is braced against the booster piston 170. This nozzle spring 182 exerts a force on the injection valve member 128 in the closing direction 134.

The hollow chamber 174 of the booster piston 170 furthermore has a circularly embodied mechanical stop 184. Upon an upward motion of the booster piston 170, this mechanical stop 184 engages an annular shoulder 186 of the injection valve member 128, which is embodied at the transition between the diameter d₃ and the diameter d₄ of the injection valve member 128. As a result, upon an upward motion of the booster piston 170, the injection valve member 128 is mechanically slaved and lifted counter to the closing direction 134. For the sake of simple assembly of the fuel injector 110, the booster piston 170 can for instance be constructed of two individual parts screwed together. The injection valve member 128 can first be inserted into a first individual part, and the second individual part can then be screwed onto the first individual part, in order to attain the construction shown in FIG. 1, in which the booster piston 170 partly surrounds the injection valve member 128.

On its lower end, the control piston 154 is surrounded by a second sealing sleeve 188, which in turn has a circular design with an inside diameter d₁ and which has a bite edge 190 on its lower end. The second sealing sleeve 180 is braced via the spring element 164 against the first sealing sleeve 160 is pressed in fuel-tight fashion against the second intermediate element 120. This creates a second control chamber 192, which is defined substantially by the second sealing sleeve 180, the second intermediate element 120 of the injector body 112, the injection valve member 128, the control piston 154, and the booster piston 170. The end faces 194 of the control piston 154 and 196 of the booster piston 170, which are oriented toward the second control chamber 192 and have the shape of circular-annular faces perpendicular to the closing direction 134, each form hydraulically effective areas 194, 196 for the control piston 154 and the booster piston 170, respectively. These hydraulically effective areas 194, 196 have the same sign with regard to the closing direction 134.

The first control chamber 166 and the differential pressure chamber 178 communicate with one another through a pressure equalization conduit 198. This pressure equalization conduit 198, in this exemplary embodiment, is embodied as a bore in the control piston 154 and in the booster piston 170; the bore in the control piston 154, for the sake of simplifying production, is composed of a blind bore extending parallel to the closing direction 134 and a bore, perpendicular to the blind bore, which is closed toward the outside with a screw. The diameter of these bores, and particularly of the bore in the booster piston 170, is selected to be large enough that even upon a relative displacement between the control piston 154 and the booster piston 170 in the closing direction 134, a flow of fuel through this pressure equalization conduit 198 is assured. In this exemplary embodiment, in the region of the booster piston 170, the pressure equalization conduit 198 has a throttle element 200 in the form of a constriction of the bore of the pressure equalization conduit 198.

The mode of operation of the fuel injector 110 in the exemplary embodiment shown will become apparent from the ensuing description of the initiation of an injection event. If the piezoelectric actuator 150 is subjected to a voltage, it expands in the closing direction 134 and acts on the control piston 154 via the control face 152, so that the control piston 154 is moved in the closing direction 134. As a result, the volume of the first control chamber 166 is increased, causing the fuel pressure p₁ in the first control chamber 166 to drop. In addition, the volume of the second control chamber 192 is briefly reduced, and as a result a fuel pressure p₂ briefly rises in the second control chamber 192. As a result of this pressure increase, a hydraulic force is exerted on the hydraulic face 196 of the booster piston 170, as a result of which the booster piston 170 is lifted counter to the closing direction 134. The ratio of the stroke h₁ of the control piston 154 and the stroke h₂ of the booster piston 170 is calculated from the ratio of the areas of the hydraulic faces 194 and 196:

$$\frac{{h}_{1}}{{h}_{2}} = - \frac{{d}_{2}^{2} - {d}_{3}^{2}}{{d}_{1}^{2} - {d}_{2}^{3}}$$

Thus the booster piston 170 is lifted by the stroke h₁ counter to the closing direction 134. Via the mechanical stop 184, the booster piston 170, by means of the annular shoulder 186, carries the injection valve member 128 along with it, so that the latter is lifted from its seat 136, as a result of which a fast first stroke of the injection valve member 128 ensues.

The drop in the pressure p₁ in the first control chamber 166 furthermore causes fuel to flow through the pressure equalization conduit 198 from the differential pressure chamber 178 above the injection valve member 128 into the first control chamber 166. In the process, the pressure p₃ in the differential pressure chamber 178 gradually conforms to the pressure p₁ in the second control chamber 166, but this pressure equalization, because of the throttle element 200, occurs in delayed fashion compared to the stroke of the booster piston 170. As a result of this drop in the pressure p₃ in the differential pressure chamber 178, an additional hydraulic force is exerted on the injection valve member 128 counter to the closing direction 134. Thus the differential pressure chamber 178, together with the first control chamber 166, acts as a second stage of a stroke boost. Thus in addition to the upward motion caused by the mechanical stop 184 and the upward motion of the booster piston 170, the injection valve member 128 is also lifted and is moved still farther from its seat 136. Overall, this lifting of the injection valve member 128 has the effect that fuel can pass via the annular chamber 151 to reach the blind borelike region 138, and from there it is injected through the injection openings 142 into the combustion chamber. By means of the two-stage stroke boost and the partly mechanical and partly hydraulic lifting of the injection valve member 128, fast opening of the injection valve can be effected, and even at short lengths of the piezoelectric actuator 150, an adequate stroke of the injection valve member 128 can be attained.

For closing the injection openings 142, once again the electrical triggering of the piezoelectric actuator 150 is suitably modified, such that the piezoelectric actuator 150 contracts, causing the control piston 154 to be lifted again counter to the closing direction 134. As a result, the pressure p₁ in the first control chamber 166 briefly rises again, and the pressure p₂ in the second control chamber 192 drops. Correspondingly, by hydraulic coupling, the booster piston 170 is moved downward, that is, in the closing direction 134. In addition, because of a pressure equalization between the first control chamber 166 and the differential pressure chamber 178, the pressure p₃ in the differential pressure chamber 178 rises, so that a hydraulic force is exerted on the injection valve member 128, and as a result the injection valve member 128 moves in the closing direction 134 until such time as the injection valve member 128 again contacts the sealing seat 136 and closes the blind borelike region 138 in fuel-tight fashion.

### LIST OF REFERENCE NUMERALS

110 Fuel injector
112 Injector body
114 Actuator chamber body
116 First intermediate element
118 Pressure chamber body
120 Second intermediate element
122 Nozzle chamber body
124 Actuator chamber
126 Fuel inlet
128 Injection valve member
130 Guide portion
134 Closing direction
136 Scaling seat
138 Blind borelike region
140 Needle chamber
142 Injection openings
144 Fuel conduit
146 Pressure chamber
148 Fuel conduit
150 Piezoelectric actuator
151 Annular chamber
152 Control face
153 Prestressing element
154 Control piston
156 Guide region
158 Shoulder
160 First sealing sleeve
162 Bite edge
164 Spring element
166 First control chamber
168 Hollow chamber
170 Booster piston
172 Relief conduit
174 Hollow chamber
176 Upper portion of the injection valve member
178 Differential pressure chamber
180 Indentation
182 Nozzle spring
184 Mechanical stop
186 Annular shoulder
188 Second sealing sleeve
190 Bite edge
192 Second control chamber
194 Hydraulically effective area of the control piston
196 Hydraulically effective area of the booster piston
198 Pressure equalization conduit
200 Throttle element

1-11. (canceled)

12. A fuel injector for injecting fuel into a combustion chamber of an internal combustion engine, the fuel injector comprising:
a) An injection valve member, movable linearly in a closing direction and via at least one sealing seat opening or closing at least one injection opening in an injector body;
b) at least one actuator acting linearly in the closing direction;
c) at least one control piston movable linearly in the closing direction by means of the actuator;
d) at least one first control chamber, in which by means of a displacement of the at least one control piston in the closing direction, a volume of the at least one first control chamber can be increased;
e) at least one booster piston hydraulically inversely coupled with the at least one control piston via a second control chamber and displaceable linearly in the closing direction the at least one booster piston being displaceable counter to the closing direction by means of a motion of the at least one control piston in the closing direction; and
f) at least one differential pressure chamber in fluid communication with the at least one first control chamber whereby the injection valve member can be subjected to a hydraulic force counter to the closing direction by means of a reduction of pressure in the at least one differential pressure chamber.

13. The fuel injector as defined by claim 12, wherein the at least one control piston is embodied at least in part as a sleeve and at least partly surrounds the at least one booster piston, and wherein the at least one control piston and the at least one booster piston are linearly displaceable counter to one another.

14. The fuel injector as defined by claim 12, wherein the at least one booster piston is embodied at least in part as a sleeve and partly surrounds the injection valve member, and wherein the at least one booster piston and the injection valve member are linearly displaceable counter to one another.

15. The fuel injector as defined by claim 13, wherein the at least one booster piston is embodied at least in part as a sleeve and partly surrounds the injection valve member, and wherein the at least one booster piston and the injection valve member are linearly displaceable counter to one another.

16. The fuel injector as defined by claim 12, wherein the at least one booster piston and/or the injection valve member comprises a slaving device for mechanically slaving the injection valve member upon lifting of the at least one booster piston counter to the closing direction.

17. The fuel injector as defined by claim 13, wherein the at least one booster piston and/or the injection valve member comprises a slaving device for mechanically slaving the injection valve member upon lifting of the at least one booster piston counter to the closing direction.

18. The fuel injector as defined by claim 14, wherein the at least one booster piston and/or the injection valve member comprises a slaving device for mechanically slaving the injection valve member upon lifting of the at least one booster piston counter to the closing direction.

19. The fuel injector as defined by claim 12, wherein the at least one first control chamber is defined substantially by the injector body, at least one first sealing sleeve, and the at least one control piston, and wherein the at least one control piston comprises a first hydraulically effective area inside the at least one first control chamber.

20. The fuel injector as defined by claim 13, wherein the at least one first control chamber is defined substantially by the injector body, at least one first sealing sleeve, and the at least one control piston, and wherein the at least one control piston comprises a first hydraulically effective area inside the at least one first control chamber.

21. The fuel injector as defined by claim 14, wherein the at least one first control chamber is defined substantially by the injector body, at least one first sealing sleeve, and the at least one control piston, and wherein the at least one control piston comprises a first hydraulically effective area inside the at least one first control chamber.

22. The fuel injector as defined by claim 16, wherein the at least one first control chamber is defined substantially by the injector body, at least one first sealing sleeve, and the at least one control piston, and wherein the at least one control piston comprises a first hydraulically effective area inside the at least one first control chamber.

23. The fuel injector as defined by claim 12, wherein the at least one second control chamber is defined substantially by at least one second sealing sleeve, the at least one control piston, and the at least one booster piston, wherein the at least one control piston comprises a second hydraulically effective area inside the second control chamber, and the at least one booster piston has a third hydraulically effective area inside the second control chamber, and wherein the second hydraulically effective area and the third hydraulically effective area have the same sign with regard to the closing direction.

24. The fuel injector as defined by claim 13, wherein the at least one second control chamber is defined substantially by at least one second sealing sleeve, the at least one control piston, and the at least one booster piston, wherein the at least one control piston comprises a second hydraulically effective area inside the second control chamber, and the at least one booster piston has a third hydraulically effective area inside the second control chamber, and wherein the second hydraulically effective area and the third hydraulically effective area have the same sign with regard to the closing direction.

25. The fuel injector as defined by claim 14, wherein the at least one second control chamber is defined substantially by at least one second sealing sleeve, the at least one control piston, and the at least one booster piston, wherein the at least one control piston comprises a second hydraulically effective area inside the second control chamber, and the at least one booster piston has a third hydraulically effective area inside the second control chamber, and wherein the second hydraulically effective area and the third hydraulically effective area have the same sign with regard to the closing direction.

26. The fuel injector as defined by claim 16, wherein the at least one second control chamber is defined substantially by at least one second sealing sleeve, the at least one control piston, and the at least one booster piston, wherein the at least one control piston comprises a second hydraulically effective area inside the second control chamber, and the at least one booster piston has a third hydraulically effective area inside the second control chamber, and wherein the second hydraulically effective area and the third hydraulically effective area have the same sign with regard to the closing direction.

27. The fuel injector as defined by claim 12, wherein the first sealing sleeve and the second sealing sleeve are braced against one another by at least one first spring element.

28. The fuel injector as defined by claim 12, wherein the at least one differential pressure chamber is defined substantially by the at least one booster piston and the injection valve member, and wherein the injection valve member has at least one fourth hydraulically effective area inside the differential pressure chamber.

29. The fuel injector as defined by claim 12, wherein the at least one first control chamber and the at least one differential pressure chamber communicate fluidically via at least one pressure equalization conduit let into the at least one control piston and/or into the at least one booster piston.

30. The fuel injector as defined by claim 29, wherein the at least one pressure equalization conduit comprises at least one throttle element.

31. The fuel injector as defined by claim 12, wherein the injection valve member is braced by at least one second spring element against the at least one booster piston, and wherein the at least one second spring element exerts a force on the injection valve member in the closing direction.
